(19) United States
(12) Patent Application Publication
(10) Pub. No.: US 2022/0145703 A1
(43) Pub. Date: May 12, 2022

(54) Improved Fall Arrest System for a Person Climbing a Ladder

(71) Applicants: Arthur Gordon Atkinson, Ilkley (GB); David Riches, St Ives (GB)

(72) Inventors: Arthur Gordon Atkinson, Ilkley (GB); David Riches, St Ives (GB)

(21) Appl. No.: 17/310,895

(22) PCT Filed: Feb. 24, 2020
(86) PCT No.: PCT/GB2020/050427

§ 371 Date: Aug. 27, 2021

(30) Foreign Application Priority Data
Mar. 4, 2019 (GB) 1902885.1

(51) Int. Cl. E06C 7/18

(52) U.S. Cl. CPC E06C 7/186

(57) ABSTRACT

A fall-arrest system for a person climbing a ladder (7) affixed to or supported by a structure, comprises: an elongate track securable to the ladder (7) so as to lie adjacent to the intended route of a person climbing or descending the ladder; a sliding device (13) which in use is coupled to the elongate track and configured to be freely displaceable therealong when the person is climbing the ladder; and a safety line (12) extending from the sliding device (13) for attachment to a harness attachment point of a safety harness worn by the person climbing or descending the ladder, the sliding device (13) incorporating a locking mechanism configured to allow the sliding device (13) to freely slide along the elongate track during normal movement of the person connected thereto by the safety line and to automatically lock the sliding device (13) to the elongate track in the event of the person falling from said ladder. The fall-arrest system is characterised in that the elongate track comprises a flexible belt (8) configured to depend from an upper end of the ladder.

### FIELD OF INVENTION

The present invention relates to an improved fall-arrest system (FAS) for persons who climb ladders in order to gain access to a higher elevation, for example on high buildings or structures where there is a risk of serious injury or death should the person accidentally fall.

### TECHNICAL BACKGROUND

A number of fall-arrest systems (FAS) have been made available in the course of time for a variety of industrial and domestic applications. Such systems serve to protect persons in situations where access to a higher elevation is required where they would otherwise be exposed to risk of serious injury or death by falling. For example, they can be used for protecting persons whilst climbing tall structures such as towers and masts or when on horizontal walkways running along the exteriors of structures, high above the ground, or on walkways above open vats or other large containers holding harmful liquids. Should a fall occur, the resulting gravitational plummet of the person is automatically arrested by the FAS, so that they are stopped before colliding with the ground, other prominent obstruction, or dangerous substance. Typically, a shock-absorbing means is incorporated into the FAS in order to limit the abruptness and magnitude of the braking or “arrest force” that is imparted to the person in order to achieve gradual retardation during the arrested fall, as this in itself could cause serious injury, but also to comply with regulatory requirements.

There are two main types of ladder used for gaining access to a higher elevation, namely the portable type, which is leant against the structure at an angle, and can be moved from location to location, and the fixed type, which is permanently secured to the vertical face of a structure using brackets.

In the case of the portable ladder type, the person requiring access leans the ladder against the wall, typically at an inclined angle of 75° in relation to the ground surface, in order to gain the optimum stability in terms of the amount of friction generated between the ends of the ladder and the ground and wall surfaces. This friction resists the tendency of the ladder to slip down the wall during climbing.

There have been many fall-related accidents involving the use of portable ladders. There are two accident categories: (i) those where the ladder becomes unstable and collapses, such that both the ladder and the person using it both fall to the ground and (ii) those where the ladder remains stable, but the person using it becomes unstable and falls to the ground.

Typical ladder instability arises in the situation, for example, where the person leans sideways at the top of the ladder in order to try and reach some feature on a building which otherwise could only be reached by descending the ladder, moving it to a more favourable position and then re-climbing it. This often leads to the ladder falling sideways or toppling over, as the centre of gravity of the person moves to a position outside the area bordered by the ladder stiles.

Other ladder instability-related accidents have occurred where the ladder has been erected at an angle of inclination of less than 75°, because the person was not comfortable climbing the ladder at this relatively steep angle. This can cause the ladder to slip down the wall, because friction is reduced. Accidents have also occurred at the other extreme where the ladder is erected at an angle of inclination greater than 75°. This can cause the ladder to fall away from the wall if the centre of gravity of the climber moves too far away from the ladder rungs.

In the case where the ladder remains stable, falls from the ladder can still occur, because the person becomes unstable. This occurs due to the loss of hand grip or the slipping of the feet from the rungs.

A number of traditional solutions have been offered in order to try and prevent these kinds of accidents. Ladders have been “footed”, where a second person stands on the lowermost rung, in order to prevent ladder instability. However, research conducted by the Health and Safety Executive has cast doubt on the effectiveness of this method. Furthermore, footing does not prevent a fall from the ladder.

Another solution has included the fitment of various ladder stability devices to the bottom of the ladder, generally consisting of types of poles and struts that rest against the ground in order to resist potential ladder instability. However, as there are no standardised methods of testing the effectiveness of these devices, potential users have to rely on the manufacturers' claims. Irrespective of whether these devices provide any additional ladder stability, the fact remains that they cannot prevent a fall from the ladder.

Perhaps the most effective solution offered to date has been the fitment of a FAS to the ladder. In the case of the vertical, fixed type of ladder, one of the traditional means of fitting a FAS has been to secure joinable sections of track to it, so that the track runs up the full length of the ladder, as disclosed in GB2373537A. An alternative has been to secure a fixed length of tensioned wire rope to the uppermost and lowermost rungs of the ladder. In both cases a fall-arrest device can be coupled to the track or wire rope, and when linked to a person's safety harness can be formed to be freely displaceable along the track or wire rope, which it does in response to climbing and descending movement. If a person falls, an inertial mechanism inside the arrest device automatically operates and causes it to lock on the track or wire rope, which arrests the fall. As the ladder is fixed to the structure it cannot become unstable, irrespective of the fall trajectory or loads applied.

However, neither of these FAS are suitable in the case of the portable type of ladder, because the FAS are of a fixed length, whereas portable ladders are predominantly of the extension type, which utilise par-axial sliding sections to enable the overall length of the ladder to be varied significantly, according to the elevation that the person needs to access. Accordingly, several lengths of FAS would have to be made available to suit the ladder length on any particular occasion, which would be impracticable.

In order to overcome this situation, a different type of FAS needed to be developed, one which could have its length adjusted in order to suit whatever length of portable ladder was set on a particular occasion. Such a FAS was developed and consists of a length of textile rope, long enough to suit the longest length of ladder. One end of the rope is connectable to the uppermost ladder rung and the other is insertable through a gripping device, which itself is connectable to the lowermost ladder rung. Once the ladder length is set, the gripping device allows excess rope to be pulled through it and hence eliminates slack between the uppermost and lowermost rungs, without the rope slipping back. If a longer length of rope is required, the mechanism within the gripping device is deactivated to allow the rope to move in either direction. Consequently, the available rope length can be shortened or lengthened to suit the length of the ladder.

As in the case of the track-based and wire-rope based FAS mentioned above, a fall-arrest device can be coupled to the textile rope, and when linked to a person's safety harness, freely displaces along the rope in response to climbing and descending movement. If a person falls an inertial mechanism inside the arrest device automatically operates and causes it to lock on the rope, which arrests the fall.

However, the portable ladder is not secured to the structure as it is in the case of the fixed type, so it has limited resistance to the motion associated with the three-dimensional trajectory characteristic of an arrested fall, or the associated loads. As the textile rope is only supported at its ends by the uppermost and lowermost rung, it cannot resist any sideways movement and tends to deflect significantly when impacted by a sideways momentum component of a fall, i.e. when a person falls to the right or left of the ladder. This can cause the ladder to become unstable, whereupon it either slips sideways to the ground or topples over. In order to prevent this, either an effective ladder stability device would need to be utilised, i.e. provable under a fall simulation test, or more reliably and typically, the ladder would need to be fastened to an anchoring means in the structure on which the ladder is leant.

The need for fastening introduces a complication, in that a hole or holes would have to be drilled in the wall against which the ladder leans, in proximity to the ladder, in order to secure an appropriate anchoring means, e.g. embedding an eyebolt in a resin adhesive compound. The ladder could then be secured by lashing or other method to the anchoring means, to guarantee stability.

Even with a stable, fastened ladder that can resist the forces and motions associated with the vertical nature of an arrested fall, the rope cannot prevent any sideways momentum component of the fall, because although tensioned, it is unsupported along its length and therefore is prone to significant sideways deflection. This can lead to a sideways fall from the ladder and a collision with the structure on which the ladder is leant against.

Research conducted by the Health and Safety Executive has shown that sideways induced impacts resulting from arrested falls on ladders can be as high as those generated by the fall-arrest system itself, and if applied to the head, can produce major injury.

In order to overcome the issues of the sideways momentum component of arrested falls, the approach that would usually be taken would be to attach the rope to the ladder at intervals between the uppermost and lowermost rungs. This would minimise sideways deflection of the rope and consequently the sideways momentum component in a fall situation. It would also reduce the impact stress on any ladder stability device or lashing means. However, this would require the use of brackets that would need to be securable to both the ladder rungs and to the rope and to be movable along the rope into a position adjacent to a rung. This would also necessitate the bracket to completely encircle the rope, which in turn would cause an obstruction to the passage of the fall-arrest device. Consequently, the fall-arrest device would need a slot or other feature in it, in order to be able to pass over the bracket whilst maintaining attachment to the rope. Such a feature would have to be designed so that, irrespective of the person's posture during climbing or descending, the slot or other feature would always be presented to align with the bracket, in order for the fall-arrest device to be able to pass over the bracket unhindered.

Consequently, this approach would cause a number of complications which would probably outweigh the usefulness of the FAS. In particular, the bracket and fall-arrest device would have to be of complicated design and therefore may be relatively expensive to produce. The fall-arrest device would also need to be ergonomic to use in order to avoid nuisance, in particular it would have to be capable of passing over the brackets without jamming, irrespective of climbing attitude.

In summary there are a number of drawbacks with existing approaches to preventing injurious falls from portable ladders. The use of traditional track-based, wire rope-based and textile rope-based FAS on leaning ladders are either impractical or ineffective. The present invention seeks to overcome these drawbacks, commensurate with ease of installation, ergonomic climbing and descent, ladder stability and safe fall-arrest performance.

### STATEMENT OF INVENTION

In accordance with different aspects of the present invention, there is provided a fall-arrest system (FAS) as defined in appended independent claims 1 and 22. Embodiments of the invention are defined in appended claims dependent on either independent claim 1 or independent claim 22.

The present invention relates to a FAS designed to arrest the fall of a person or persons should they fall whilst climbing or descending a ladder. It comprises a safety track held by track supports in spaced relation to a ladder, and a coupling component for connecting a person's safety harness to the said track via a safety line, said component being coupled to said track but being freely displaceable therealong. Such supports and the coupling component can be formed so that the displacement of the coupling component along the track is not obstructed by the supports.

A first aspect of the present invention is utilisable on both main types of ladder, i.e. the portable type and the fixed type. According to the first aspect of the present invention, there is provided a fall-arrest system for persons climbing a ladder on a structure, comprising:
an elongate track securable to the ladder so as to lie adjacent to the intended route of person climbing or descending the ladder;
a sliding device which in use is coupled to the elongate track and configured to be freely displaceable therealong when the person is climbing the ladder; and
a safety line extending from the sliding device for attachment to a harness attachment point of a safety harness worn by the person climbing or descending the ladder, the sliding device incorporating a locking mechanism configured to allow the sliding device to freely slide along the elongate track during normal movement of the person connected thereto by the safety line and to automatically lock the sliding device to the elongate track in the event of a person falling from said ladder;
characterised in that the elongate track comprises a flexible belt configured to depend from an upper end of the ladder.

Most fall arrest systems employ a track of textile rope, metal cable or metal track, see for example EP2578766, EP2581115, US2019/060683, U.S. Pat. No. 3,908,791 and US2010/326768. The first aspect of the present invention uses a flexible belt, which has a cross section with a width greater than its thickness, for example a rectangular cross section. When such a belt is mounted vertically on a ladder, with its width aligned parallel to the rungs of the ladder, and tension applied, the flexible belt has a high resistance to lateral displacement. In this way, a flexible belt is better suited than for example a rope of circular cross section in helping to prevent a person at risk of falling sideways from a ladder.

In one arrangement, the flexible belt comprises: a first flexible belt component configured to be secured to the ladder; and a second flexible belt component secured to the first belt component by a plurality of linkages spaced along the first and second flexible elongate components, the plurality of linkages being configured to maintain a gap between the first and second flexible belt components and to allow the sliding device to slide freely along the second flexible belt component. An uppermost portion of the flexible belt may be configured to be attached to the uppermost rung of the ladder by a top mounting bracket, and a lower portion may be configured to be attached to the lowermost rung of the ladder, perhaps using a combined tensioning device with bracket.

The sliding device may comprise a part defining an open channel for slidably receiving the second elongate flexible belt component therethrough, the open channel having a profile which is configured to retain the second flexible belt component therein whilst allowing the sliding device to pass at least one of the plurality of linkages when sliding along the second elongate flexible belt component. The second or frontmost flexible belt component nearest the person climbing the ladder provides the portion of the elongate track upon which the sliding device slides in response to normal climbing or descending movement and locks to the belt in the event of a fall. Internal surfaces of the open channel in the sliding device engage the rear faces of the frontmost flexible belt component, allowing the sliding device to slide along the flexible belt but preventing the sliding device from being pulled off the flexible belt in a direction transverse to the flexible belt surfaces.

The fall-arrest system may further comprise at least one coupling configured to secure the first flexible belt component to a rung of the ladder, the at least one coupling being slidable along the first flexible belt between an adjacent pair of the plurality of linkages. The or each coupling may comprises a sleeve through which the first elongate flexible belt component is threaded. For example, the first or rearmost flexible belt component nearest the ladder may be threaded through belt-receiving sleeves that completely encircle the belt. These sleeves form part of the couplings that are securable to the rungs of the ladder at intermediate positions between for example the uppermost rung with the top mounting bracket and the lowermost rung with the combined tensioning device with bracket. These couplings can slide along the rearmost flexible belt component in between the linkages joining the two belt components together. This allows the couplings to be aligned with a rung for attachment and so is connectable to a rung despite any variation in ladder dimensions.

The plurality of linkages and the sliding device may be formed so that displacement of the sliding device along the elongate track is not obstructed by the plurality of linkages nor the at least one coupling configured to secure the first flexible belt component to a rung of the ladder.

In another arrangement, at least a portion of the safety line is rigid or substantially rigid such that, when the portion of the elongate track on which the sliding device is positioned is orientated in a vertical or inclined direction, the sliding device is supported on the harness attachment point via the substantially rigid portion of the safety line, maintaining the sliding device above the harness attachment point minimising the distance through which a person might free fall before the locking mechanism is actuated in the event of a fall. The phrase “rigid or substantially rigid” in relation to the safety line is taken to mean having sufficient rigidity to enable the sliding device to be pushed up the track means by a force applied to the safety line via the harness attachment point as the person ascends the ladder.

By means of the substantially rigid portion of the safety line the sliding device is automatically urged up the track means ahead of the harness attachment point as a person wearing the safety harness ascends the ladder and automatically descends the track means under the action of gravity as the person descends the ladder.

The rigid or substantially rigid portion of the safety line may comprise a rigid or substantially rigid tube encasing the safety line. The tube may be of fixed length or may be telescopically extendible and retractable to adjust to the length of said substantially rigid portion of the safety line. The safety line encased by the rigid or substantially rigid tube may be wound on a spring-loaded reel within the body of the sliding device such that it is automatically extendible and retractable. The spring-loaded reel may comprise a rotary locking mechanism to lock the reel if the reel rotates at a velocity exceeding a predetermined limit which is indicative of a person falling off the ladder. This would enable the safety line to automatically adopt a fixed, relatively short length when the sliding device travelling on a vertical or inclined section of the track means wherein the sliding device is maintained above the harness attachment point, by virtue of the substantially rigid tube, but would become automatically extendible to provide a variable length when the sliding device is stationary, when for instance, a person wishes to transition from the top of a ladder onto a walkway whilst maintaining connection to the ladder.

Preferably the locking mechanism incorporated in the sliding device is configured to lock the sliding device to the elongate track in response to a pulling force applied to the sliding device via the safety line when said force has a component parallel to the elongate track in a direction away from the sliding device.

The sliding device comprises a first part (which may also be referred to as a housing) engaging the flexible belt and a second part (which may also be referred to as a locking frame) coupled to the safety line, with the second part configured to move relative to the first part from a first position to a second position to activate the locking mechanism in order to lock the sliding device to the flexible belt. The first part may define an open channel having a profile configured to receive and retain the flexible belt therein when sliding therealong, The profile may be configured to allow the sliding device to pass a linkage anchoring the flexible belt to the ladder. The second part may be constrained to move relative to the first part from the first position to the second position in a direction parallel to the flexible belt engaging the first part. For example, slidable constraint may be provided by an upper and lower slot in the second part coincidental with an upper and lower spindle traversably mounted across the first part of the sliding device. In use, the safety line may be coupled to the second part adjacent the flexible belt engaging the first part.

By coupling the safety line to the second part at a position close to the plane of the flexible belt, rather than directly to the locking mechanism, and allowing the second part to slide relative to the first part between the first and second positions, the present applicant has found that the sliding device is less likely to induce a forward tilting moment capable of deflecting the flexible belt which may interfere with a smooth sliding action when ascending the ladder.

The locking mechanism may comprise a locking lever pivotally coupled to the first part, the locking lever having: a distal end furthest from the flexible belt which is pivotally coupled to the second part; and a proximal end closest to the flexible belt which is configured to pivot towards the flexible belt in response to movement of the second part relative to the first part from the first position to the second position. The locking lever may be configured to trap the flexible belt between the proximal end and the first part in response to movement of the second part relative to the first part from the first position to the second position. Pivotal movement of the proximal end may be guided by engagement of the locking lever with a surface (e.g. spindle) of the first part as the second part moves relative to the first part from the first position to the second position. The pivotal coupling of the locking lever to the first part may allow translational movement of the locking lever towards the flexible belt.

The second part may be urged to remain in the second position relative to the first part by a resilient bias (e.g. provided by an extension spring). The resilient bias may be configured to be exceeded by an opposing force transmitted to the second part by the safety line and created during controlled ascent or descent, whereby the second part moves to the first position. The resilient bias may also be configured to move the second part from the first position to the second position as soon as the opposing force is removed, and particularly in the event of a person falling from the ladder.

The proximal end of the locking lever may be serrated, lined with braking material or other roughening means, such that downward pivotal movement of the distal end of the locking lever, in response to a force applied to the second part (or locking frame), via the safety line, in a direction parallel to the elongate track and away from the sliding device, brings said proximal end of the locking lever into locking engagement with a surface of the elongate track. A stop member may be provided preventing the locking lever from engaging the surface of the elongate track when a force is applied to the second part (or locking frame), via the safety line, close to the plane of and in a direction parallel to the elongate track and towards the locking mechanism, preventing the locking mechanism from being actuated when a pushing force is applied to the sliding device via the safety line. As the pushing force is indirectly applied to the locking lever via the second part (or locking frame), which may be situated low (i.e. adjacent the elongate track) within the first part (or housing) of the sliding device, “twisting movements” may be avoided. In this way, a tendency for the sliding device to dig into the elongate track and impede sliding device movement along the elongate track which would occur if the pushing force via the safety line were directly applied to the locking lever, may be reduced or avoided altogether.

In the FAS according to the first aspect of the invention, the relative positioning of the harness attachment point and sliding device is such that free fall is negligible and consequently the degree of fall-generated energy is relatively small. As a result, a person can be arrested at a lower arrest force and in a shorter distance, because the free fall component of a fall is virtually eliminated. This greatly reduces the possibility of collision with the structure due to sideways falls and reduces the possibility of secondary injuries, caused by impacts between a person and the ladder and between a person and the FAS during an arrested fall. Furthermore, the virtual elimination of free fall and the reduction in possibility of secondary injuries caused by potential collisions with structure, makes the FAS according to the first aspect of the invention most suitable and desirable for use within caged or hooped ladders, which consist of an assembly of circular steel hoops and vertical straps which enclose the path of a person climbing or descending a ladder, such enclosure being severely confined in nature, such confinement of which virtually guarantees secondary injuries due to collision with the cage as a result of an arrested fall using a conventional FAS, due to unrestrained outward motion of a fall away from the ladder, which the present invention seeks to eliminate by causing an inward fall towards the ladder.

In one arrangement, the flexible belt may have teeth configured to mesh with and rotate a cogwheel rotatably mounted in the sliding device as the sliding device slides along the flexible belt, with the locking mechanism of the sliding device being configured to stop further rotation of the cogwheel if rotation of the cogwheel exceeds a predetermined angular velocity.

For example, the locking mechanism may comprise a cogwheel mounted within a housing of the sliding device, constrained to rotate about its central axis, with teeth radially disposed and being so formed and at a frequency to mate with receiving teeth formed on the flexible belt, said cogwheel and belt being in such close proximity that the cogwheel is spun in response to the sliding device being pushed up and down the belt, said cogwheel driving a locking mechanism operable when reaching a magnitude of angular velocity, whereupon the cogwheel is locked in place and is prevented from further rotation thus locking the position of the sliding device to the belt, characterised by when the sliding device ascends and descends in response to normal climbing movement, the cogwheel is spun in response by it being mated with the belt but at an angular velocity insufficient to actuate said locking mechanism, allowing the sliding device to move up and down the belt in response to climbing movement, but when a fall suddenly occurs, the resulting gravitational plummet causes said cogwheel to spin in response to it being mated with the belt and reach an angular velocity whereupon said locking mechanism operates and causes the cogwheel to be locked in place and is prevented from further rotation thus locking the position of the sliding device to the belt and arresting the fall, this aspect being advantageous in that the grabbing of the sliding device or safety line in the panic of a fall has no effect on the ability of the sliding device to lock to the belt and in that a fall in a direction away from the ladder or to the side of the ladder has no effect on the ability of the sliding device to lock to the belt.

A second aspect of the present invention is utilisable on the fixed type of ladder. In accordance with the second aspect of the present invention, there is provided a fall-arrest system for a person climbing a ladder affixed to a structure, comprising:
a first pulley rotatably mounted at an upper end of the ladder;
a second pulley rotatably mounted at a lower end of the ladder;
a continuous loop belt disposed around the first and second pulleys;
a coupling device attached to one portion of the continuous loop belt between the first and second pulleys, with movement of the device between the first and second pulleys driving rotation of the continuous loop belt around the first and second pulleys;
a safety line extending from the coupling device for attachment to a harness attachment point of a safety harness worn by the person climbing or descending the ladder, wherein at least one of the first and second pulleys comprises a braking mechanism configured to allow the coupling device to drive rotation of the continuous loop belt around the first and second pulleys during normal movement of the person connected thereto by the safety line and to automatically stop rotation of the continuous loop belt around the first and second pulleys in the event of the person falling from said ladder.

In one arrangement, the braking mechanism may be activated automatically when at least one of the first and second pulleys rotates at an angular velocity exceeding a predetermined limit which is indicative of a person falling off the ladder.

In one arrangement, the continuous loop belt comprises teeth which mesh with a corresponding profile on at least one of the first and second pulleys. For example, both of the first and second pulleys may have the corresponding profile to mesh with teeth of the continuous loop belt.

In one arrangement, the first pulley comprises the braking mechanism. The second pulley may have an external drive mechanism for controlled rotation of the continuous looped belt around the first and second pulleys following activation of the braking mechanism and a person's fall has been arrested. The external drive mechanism may configured initially to raise the arrested person to deactivate the braking mechanism before lowering the arrested person. The external drive may have a crank handle for manual operation.

For example, in relation to the second aspect of the invention, a continuous toothed belt is tensioned and looped around the first and second (i.e. upper and lower) pulleys, situated at the extremes of the ladder so that the toothed belt runs up the front side of the ladder around the upper pulley and down the back side of the ladder and around the lower pulley. The coupling device, connected to a person's harness via the safety line, may be clampable and therefore fixed to the toothed belt and does not slide on said belt. The upper and lower pulleys may be constrained to rotate about their respective central axes, with teeth radially disposed and being so formed and at a frequency to mate with receiving teeth formed on the toothed belt, said upper and lower pulleys and belt being in such close proximity that the upper and lower pulleys are spun in response to the coupling device being pushed upwards and downwards in response to climbing movement. The upper pulley may drive an internal braking mechanism operable when reaching a predetermined magnitude of angular velocity which corresponds to a person falling of the ladder, whereupon the upper pulley is locked in place and is prevented from further rotation thus locking the position of the toothed belt to the upper pulley. Furthermore, when the coupling device is pushed upwards and downwards in response to normal climbing movement, the upper pulley is spun in response by it being mated with the belt but at an angular velocity insufficient to actuate said braking mechanism, allowing the coupling device to be pushed upwards and downwards in response to climbing movement. This aspect is advantageous in that any grabbing of the coupling device or safety line or drive belt in the panic of a fall has no effect on the ability of the upper pulley to lock to the belt and in that a fall in a direction away from the ladder or to the side of the ladder has no effect on the ability of the upper pulley to lock to the belt.

Once a person's fall has been arrested, the arrested person may be left in post-fall suspension, where they may expire due to a collapse in metabolism known as suspension trauma. Accordingly, immediate rescue and recovery of the fallen person may become critical. In one arrangement, such rescue and recovery may be achieved by operation of the lower pulley, said lower pulley constrained to rotate about its central axis, with teeth radially disposed and being so formed and at a frequency to mate with receiving teeth formed on the toothed belt, said lower pulley and belt being in such close proximity that the lower pulley is spun in response to the sliding device being pushed upwards and downwards in response to climbing movement, but having no internal locking mechanism sensitive to angular velocity does not lock-up in the event of a fall and is therefore free to rotate even when the upper pulley is locked to the toothed belt. Thus, when a second person at ground level or other safe zone comes to rescue and recover said arrested person in post-fall suspension, a cranking handle may be insertable into the spindle of the lower pulley and be initially turned to raise said arrested person in post-fall suspension, releasing the locking mechanism in the upper pulley so that it becomes free again to rotate about its axis, allowing the said arrested person in post-fall suspension to be lowered by the second rescue and recovery person by operating the cranking handle in the opposite direction until the said arrested person in post-fall suspension reaches the ground or other safe zone. This aspect is advantageous in that an arrested person in post-fall suspension can be remotely rescued and recovered by a second rescue and recovery person on the ground or other safe zone without the need to climb the ladder and put themselves at risk of a fall from a height and without any additional rescue and recovery equipment and that the rescue and recovery can be effected in a rapid timescale in order to minimise the possibility of the arrested person in post-fall suspension becoming endangered by suspension trauma.

### BRIEF DESCRIPTION OF THE DRAWINGS

The invention will be described further, by way of example, with reference to the accompanying drawings, in which:

FIG. 1 is a perspective view of a portable extension ladder being used in a typical application;

FIG. 2 is a perspective view of a fixed vertical ladder being used in a typical application;

FIG. 3 is a perspective view of a worker climbing a portable extension ladder in a typical elevated situation whilst using the FAS according to one embodiment of the present invention;

FIG. 4 is an external perspective view of a sliding device of the FAS in FIG. 3;

FIGS. 5a and 5b are sectional views of the sliding device of FIG. 4;

FIGS. 6a and 6b are side and perspective views of a worker climbing a fixed vertical ladder in a typical elevated situation whilst using the FAS in FIG. 3;

FIG. 7 is a perspective view of a worker exiting the top of a ladder whilst using the FAS in FIG. 3;

FIG. 8 is a perspective view of a belt track with twin belt components, used in the FAS of FIG. 3;

FIG. 9 is a perspective view of a worker climbing inside a caged ladder in a typical elevated situation whilst using the FAS according to one embodiment of the present invention;

FIGS. 10a and 10b show plan and part sectional/part side views of a device for applying tension to a flexible belt; and

FIG. 11 shows a partly sectioned side view of an embodiment of a belt track incorporating a continuous toothed belt being operated over two pulleys, according to another embodiment of the present invention.

### DESCRIPTION OF SPECIFIC EMBODIMENTS

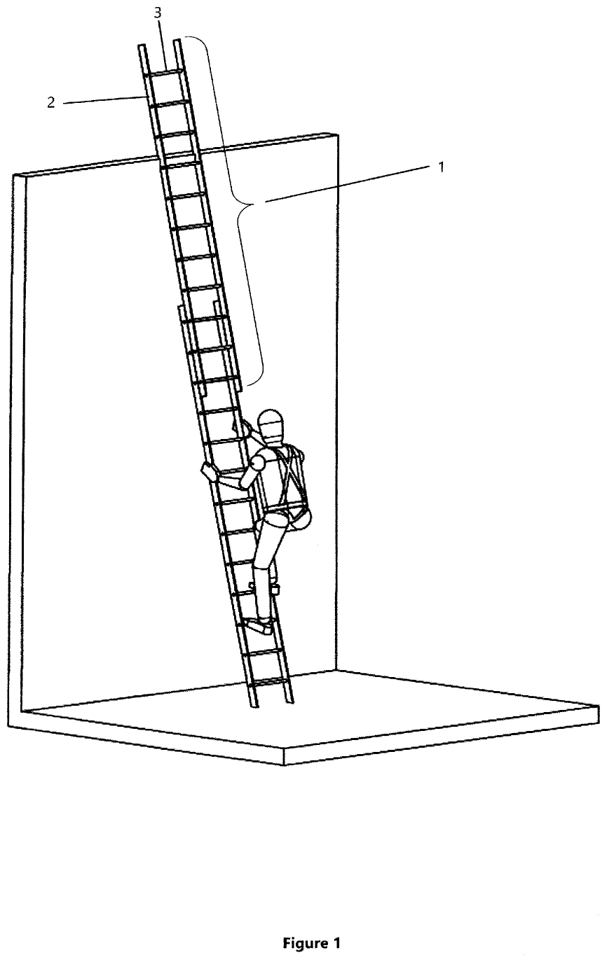

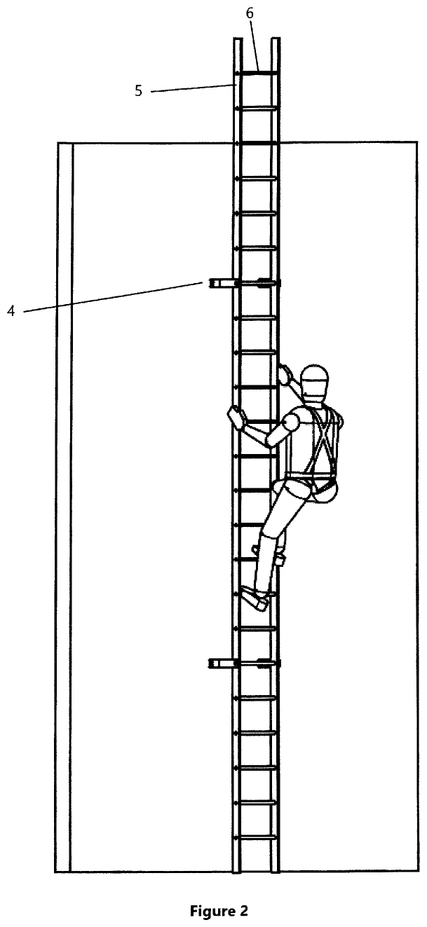

FIGS. 1 and 2 illustrate the two main kinds of the ladder. FIG. 1 is a perspective view of a portable extension ladder being used in the typical application of gaining access to a higher elevation by leaning it against the structure, consisting of overlapping par-axial extensions 1, side members or stiles 2 and rungs 3. FIG. 2 is a perspective view of a vertical ladder being used in the typical application of gaining access to a higher elevation by having previously been fixed to the structure with brackets 4, showing stiles 5 and rungs 6.

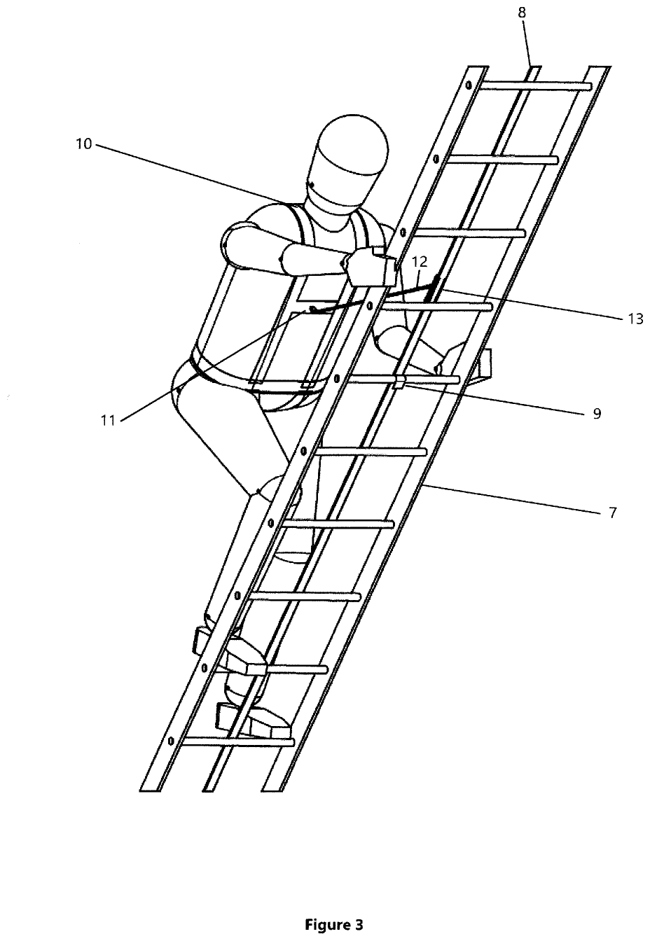

The FAS illustrated and attached to a secured portable ladder 7 in FIG. 3 shows the belt track 8 according to one embodiment of the present invention. (The ladder securing means is not shown, for clarity). This track runs alongside a person's climbing route and is held closely spaced from the ladder by couplings or brackets 9 which are attached to the ladder rungs.

The person is wearing a safety harness 10, which is connected at a sternal harness attachment point 11 to a rigid safety line 12 of a sliding device 13. The rigid safety line 12 is of fixed length whilst the FAS is operated in the climbing direction, which causes the sliding device 13 to be pushed up the track 8 ensuring that the harness attachment point always remains below the sliding device 13.

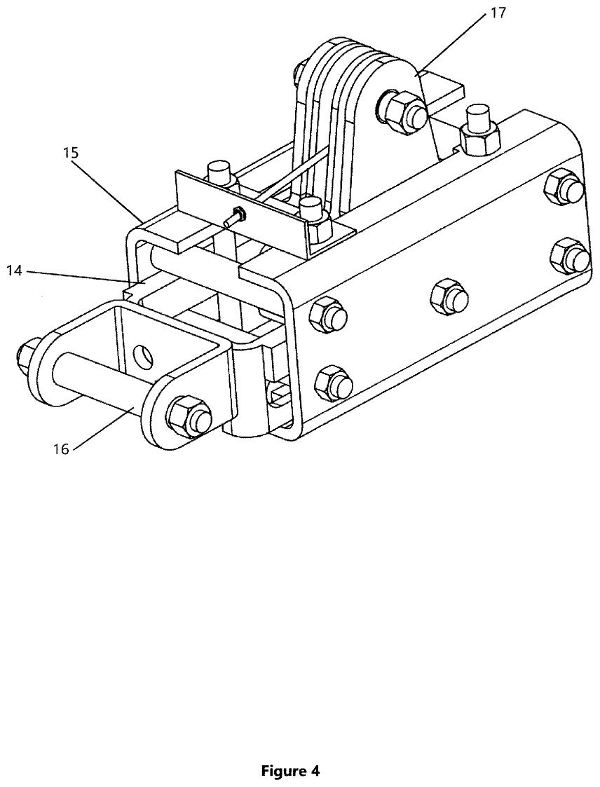

FIG. 4 illustrates one embodiment of the sliding device 13 showing a second part (hereinafter referred to as “the slidable locking frame 14”), constrained within a first part (hereinafter referred to as “the housing 15”), with attachment 16 for safety line 12 and an external lug 17.

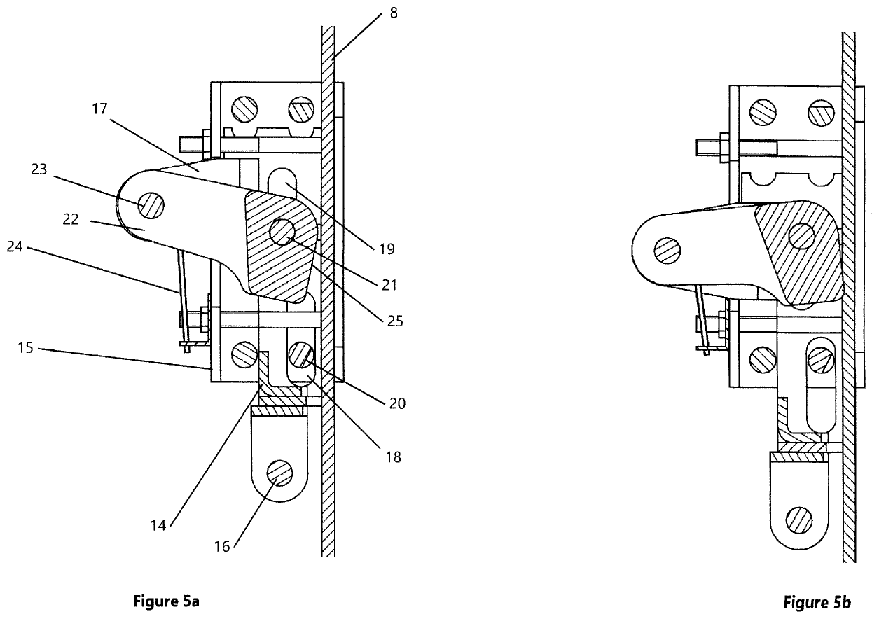

FIGS. 5a and 5b shows the internals of one embodiment of the sliding device 13 as it slides on the belt track 8. FIG. 5a shows the unlocked state of the sliding device, whereupon it is free to slide on the belt track 8. Locking frame 14 is slidably constrained in a direction parallel to the belt track 8 provided by lower slot 18 and upper slot 19 coincidental with lower spindle 20 and upper spindle 21. The locking frame 14 includes the external lug 17 which is pivotally connected by a bolt 23 to the distal end of a locking lever 22, which in addition proximally pivots about spindle 21. Any upwards rotation of the locking lever 22 is resisted by an extension spring 24 which itself is connected to both the locking lever 22 and the housing 15.

The distal end of the locking lever 22, furthest from the belt track 8, is external to and protrudes through a slot in the housing 15. The proximal surface 25 of the locking lever 22 nearest the belt track, may be serrated, lined with braking material or other roughening means.

When an upwards pushing force is applied via the safety line 12 when in the climb, or when the weight of the sliding device is applied to the safety line 12 when in the descent, the force, whether the pushing force in the climb or the sliding device weight in the descent, is applied to the safety line attachment, causing the locking frame 14 to slide upwards over spindles 20 and 21, causing the locking lever 22 to pivot upwards about spindle 21, extending extension spring 24 and causing a clearance to be generated between belt track 8 and proximal surface 25 of locking lever 22. As the said pushing force or sliding device weight is indirectly applied to the locking lever 22 via the locking frame 14, any twisting tendency for the sliding device to dig into the into the belt track 8 and impede sliding device movement along the belt track 8, which would occur if the said pushing force or sliding device weight via the safety line 12 were directly applied to the locking lever 22 at connection 23, is otherwise avoided.

FIG. 5b shows the locked state of the sliding device, which occurs when the locking lever 22 jams against belt track 8 in the event of a fall. When a person initially falls from the ladder, the pushing force if climbing or reaction force to the sliding device weight if descending in the safety line 12 momentarily decays to such an extent that the extension spring 24 pulls the distal end of the locking lever 22 downwards about spindle 21, causing the proximal surface 25 of the locking lever 22 to jam against the belt track 8, such that the sliding device 13 resists any further movement down the belt track 8. This in effect creates an anchor point and so resisting the initial motion of the fall, the continuing momentum of which applies an arrest force downwards via the safety line attachment 16, forcing the locking frame 14 to slide downwards and ipso facto the external lug 17, causing the distal end of the locking lever 22 to be forced downwards about spindle 21 and consequently applying more pressure to proximal surface 25 of the locking lever 22, to such an extent braking contact between proximal surface 25 and belt track 8 defrays the energy of the fall by the friction caused and heat so lost until the fall is brought to a complete stop.

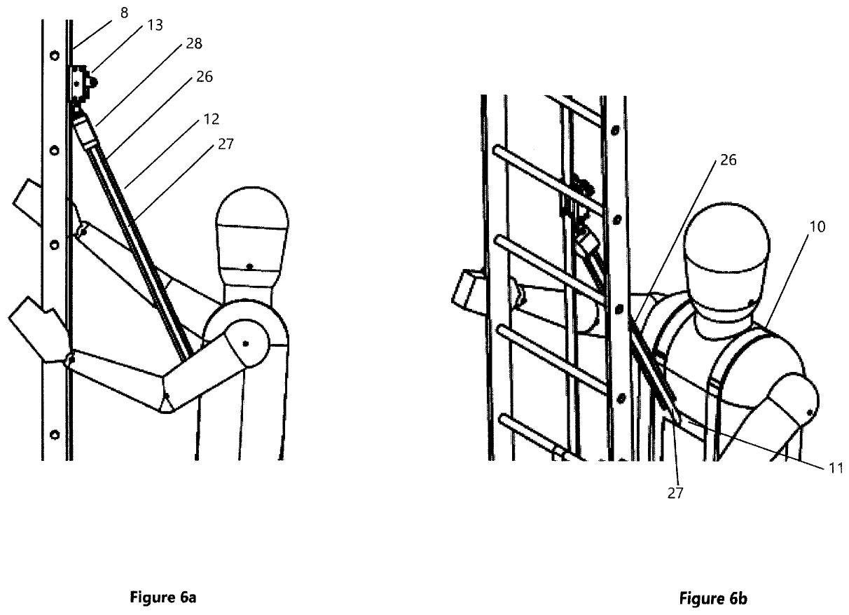

FIGS. 6a and 6b show the use of one embodiment of the FAS. The person is wearing a safety harness 10, which is connected at a sternal harness attachment point 11 to the safety line 12 of the sliding device 13, which is being pushed up belt track 8 by the climbing action of the person. In this embodiment, the safety line 12 is a composite assembly, comprising an outer rigid tube 26, an inner flexible safety line 27 and a self-retracting reel 28 which connects to the locking frame 14 of the sliding device 13, for storing the inner flexible safety line 27.

The inner flexible safety line 27 can typically be made of a textile webbing, the lower end of which is connected at the sternal harness attachment point 11 on the safety harness 10. The other end of the inner flexible safety line 27 is attached to and wound on to the self-retracting reel 28. The outer rigid tube 26 is of fixed length, encases and is able to slide on the inner flexible safety line 27 but is not attached to it, nor is it attached to self-retracting reel 28 or harness attachment point 27.

The self-retracting reel 28 comprises the wound storage of a length of inner flexible safety line 27, a torsion spring and an inertial locking mechanism (all not shown). The purpose of the torsion spring is to maintain a light tension on the inner flexible safety line 27 at all times and facilitates the automatic extraction and retraction of the safety line 27 in response to the person's movement, without any slack being able to develop in the safety line 27, much like the passenger retracting seat belt arrangement found in modern motor vehicles.

When a person climbs up a ladder, the harness attachment point 11 abuts the bottom of the outer rigid tube 26 and said tube being rigid, pushes against the reel 28 and sliding device 13, causing the sliding device 13 to slide up the belt track 8. When descending, the weight of the sliding device 13 and reel 28 cause the sliding device to slide down the belt track 8. Both in the climb and descent the length of inner flexible safety line 27 extracted from reel 28 and inside the outer rigid tube 26 remains the same length as the outer rigid tube 26.

In the event of a fall, the sliding device 13 locks to the belt track 8 as described above. This causes the inner flexible safety line 27 to rapidly extract from the self-retracting reel 28. When this extraction speed reaches a pre-determined limit, the inertial locking mechanism inside the reel causes the reel to lock about its spindle and to prevent further extraction. This decelerates and brings to the fall to a halt. The outer rigid tube 26 slides down the inner flexible safety line 27 in response to the extraction and exposes the said safety line where it exits the reel 28.

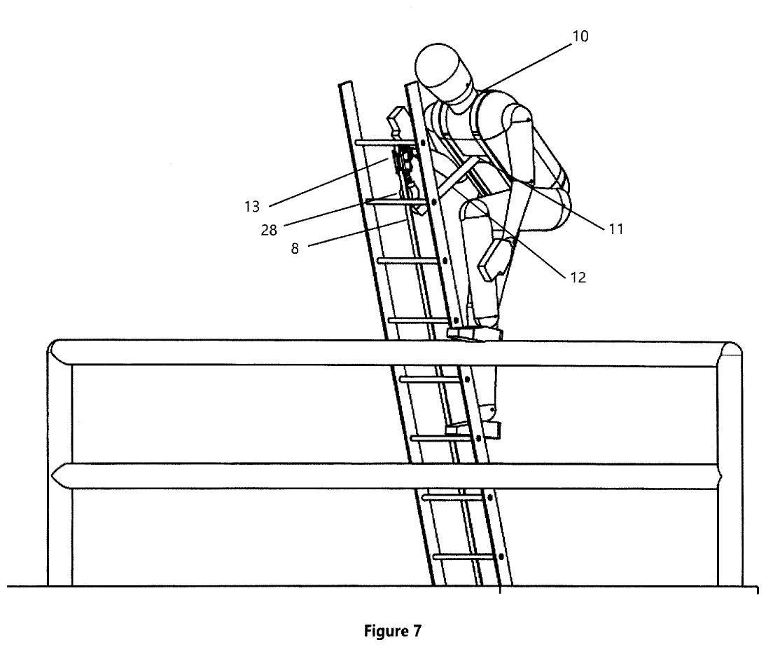

This particular arrangement has no real advantage over the basic, fixed length safety line embodiment shown in FIG. 3, until the situation is considered where a person wishes to exit from the top of the ladder, as shown in FIG. 7.

It is essential to facilitate protection from falling when transiting from the ladder onto an adjacent surface or platform, as often this movement can be difficult from an ergonomic viewpoint, for instance when stepping over a guard rail or scaffold pole as shown in FIG. 7, and exposes persons so doing to a risk of falling. Sometimes this movement can be so difficult that a person will disconnect themselves from the very FAS that is protecting them, in order to facilitate the transfer, which can be very dangerous.

FIG. 7 shows a person exiting from the top of a secured ladder, (method of securing not shown), whilst negotiating a guard rail in order to gain access to the level on the safe side of the guard rail, utilising the same embodiment of the invention as described in FIGS. 6a and 6b, said person wearing a safety harness 10, which is connected at the sternal harness attachment point 11 to the composite safety line 12 of the sliding device 13, which is on belt track 8.

The advantage of the composite safety line assembly 12, is that during the climb, the composite safety line assembly 12 is of fixed length, necessary to ensure that the sliding device 13 is maintained at a position above the harness attachment point 11 in order to minimise free fall, whereas when coming to exit from the ladder, the composite safety line assembly 12 becomes variable in length, facilitated by the self-retracting reel 28. The extraction and retraction of the safety line 12 in response to the person's movement, whilst preventing slack developing in the safety line, allows, in particular, those movements and postures requiring a greater length of safety line than that in the climb, to be adopted in order to negotiate exiting from the ladder, without having to disconnect from the FAS and therefore providing full protection from falling.

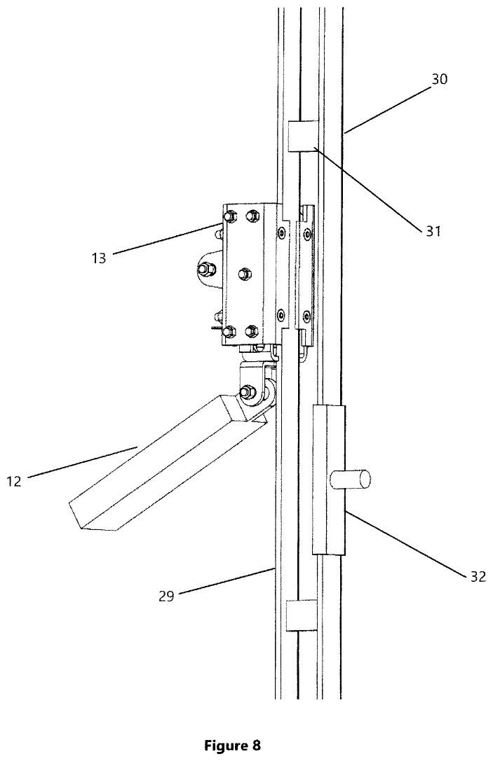

FIG. 8 shows an embodiment of the belt track invention, which consists of twin or first and second belts, the rearmost belt 30 and the frontmost belt 29. The two belts are joined at intervals using a plurality of linkages or spacers 31. The uppermost and lowermost portions of the twin belts where they connect to the ladder are not shown.

The rearmost belt 30 is installed nearest the ladder and is threaded through belt receiving sleeves 32 that completely encircle the belt 30. The belt receiving sleeves 32 form part of the couplings or brackets 9 that are secured to the ladder rungs (FIG. 3) at intermediate positions between the upper and lower attachment points of the belts to the ladder.

During installation, the belt receiving sleeves 32 may be moved along the rearmost belt 30 in between spacers 31, allowing alignment with a rung for attachment purposes despite any variations of rung pitch.

The frontmost belt 29 is installed so to be nearest the person climbing the ladder and provides the portion of the track upon which the sliding device 13 slides in response to normal climbing or descending movement and locks to the frontmost belt 29 in the event of fall (FIG. 5).

The belt spacers 31 and the sliding device 13 are formed so that displacement of the sliding device 13 along the track is not obstructed by the spacers 31 or the belt receiving sleeves 32. For example, the sliding device 13 comprises a part defining an open channel for slidably receiving the frontmost belt 29 therethrough, the open channel having a profile which is configured to retain the frontmost belt 29 therein whilst allowing the sliding device 13 to pass at least one of the plurality of linkages 31 when sliding along the frontmost belt 29.

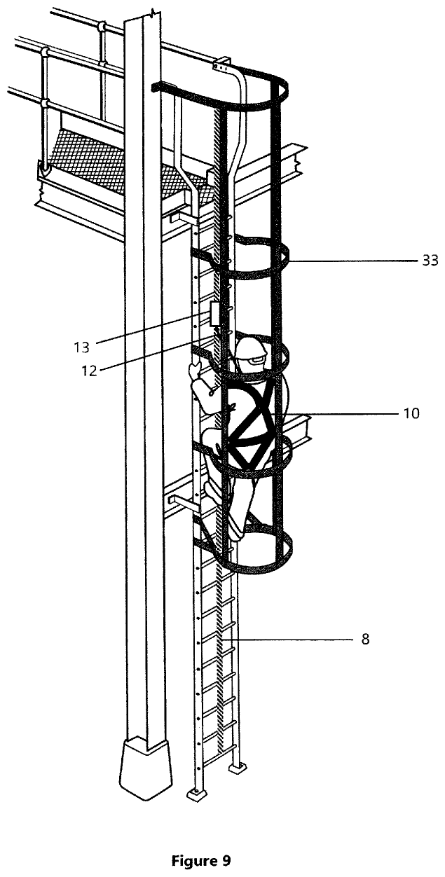

The use of the FAS according to one embodiment of the present invention is shown in FIG. 9 in the situation where a person has to climb inside a caged ladder 33, comprising belt track 8, safety harness 10, rigid safety line 12 and sliding device 13. The rigid safety line 12 is of fixed length whilst the FAS is operated in the climbing direction, which causes the sliding device 13 to be pushed up the track 8 ensuring that the harness attachment point always remains below the sliding device 13. This ensures that in a fall scenario free fall is minimised and fall motion tends to be inwards away from the cage, both of which minimise the potential for secondary injuries caused by localised impacts which may occur when in the confines of a cage.

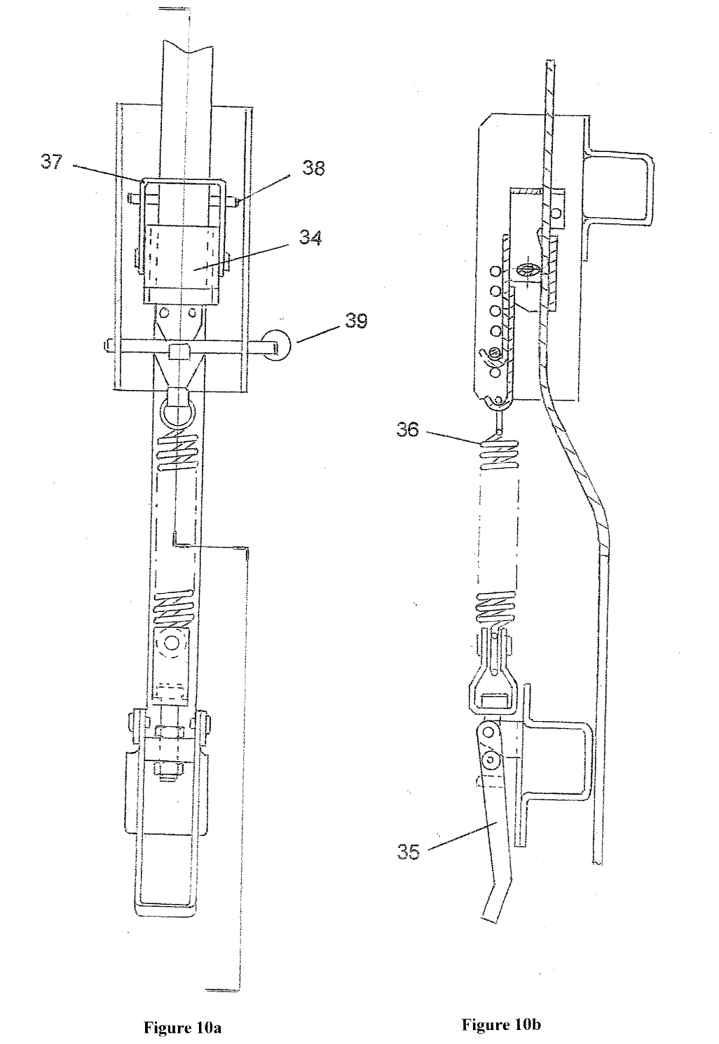

FIGS. 10a and 10b show plan and part sectional/part side views of a device for applying tension to a flexible belt track 8. The device includes a belt securing clip 34 for releasably engaging the flexible belt track 8, and an arrangement with an over-centre tensioning latch 35 which in use is configured to be secured to the ladder 7. The belt securing clip 34 is threaded onto the flexible belt track 8. A lever of the over-centre tensioning latch 35 is raised to its highest position until a spring 36 is hooked onto the belt securing clip 34. Excess slack in the flexible belt track 8 is taken up before a clamping cam lever 37 of the belt securing clip 34 is moved to clamp the flexible belt track 8 and a retaining pin 38 is inserted behind the flexible belt track 8. The lever of the over-centre tensioning latch 35 is moved downwards to apply tension to the flexible belt track 8 via the spring 36. A tension retaining pin 39 may then be used to anchor the belt securing clip 34 to the ladder 7.

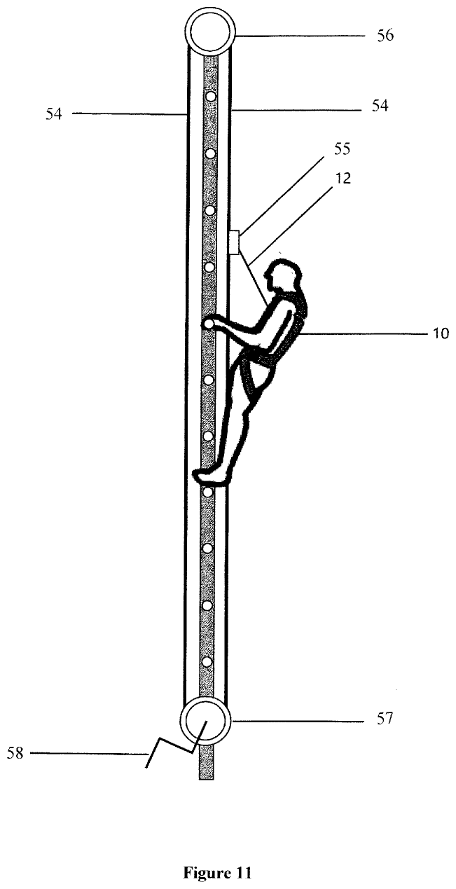

FIG. 11 shows an embodiment of further aspect of the present invention, which consists of a continuous toothed belt 54 which is looped and tensioned around the front and rear of a ladder and an upper pulley 56 and lower pulley 57. For clarity, the brackets 4 that fix the ladder to structure are not shown. A clamp 55 is clamped to the toothed belt 54. The rigid safety line 12, is connected between the safety harness 10 worn by the person climbing the ladder and the clamp 55.

As the clamp 55 is fixed to the toothed belt 54, any climbing or descending movement of the person is transmitted via the rigid safety line 12, causing the toothed belt 54 to be moved upwards or downwards. The upper pulley 56 and lower pulley 57 have radial teeth spaced with grooves (not shown) that mate with the teeth of the toothed belt 54, such that up and down movement of the toothed belt 54 causes the both pulleys to rotate.

The upper pulley 56 contains an internal locking mechanism (not shown) which is sensitive to angular velocity, similar in operation to the reel described in FIG. 6a. When the toothed belt 54 is pushed up and down by climbing or descending movement, the upper pulley is spun in response by it being mated with the toothed belt 54 but at an angular velocity insufficient to actuate the locking mechanism of the upper pulley 56. If a fall occurs, the sudden gravitational plummet causes the toothed belt to pulled downwards rapidly, causing the locking mechanism of the upper pulley 56 to operate due to the sudden increase in angular velocity, similar in function to the retractable seat belt of a modern motor vehicle, causing the fall to be arrested.

The lower pulley 57, having no internal locking mechanism, simply spins in response to normal climbing movement or the rapid movement associated with a fall. After a fall has taken place and the arrested person is left in suspension on the toothed belt 54, a cranking handle 58 may be inserted within the lower pulley 57 for the purposes of remotely rescuing the faller by a second person on the ground or other safe platform.

The cranking handle 58 may be turned initially to raise the arrested person, releasing the locking mechanism of upper pulley 56, so that it becomes free again to spin on its axis and allowing the second person to slowly lower the arrested person to the ground or other safe platform. This arrangement is advantageous in that an arrested person can be remotely rescued by a second person from a place of safety without the need to climb the ladder and put themselves at risk of another fall, it eliminates the need for any additional rescue equipment or services and the rescue can be effected in a rapid timescale in order to minimise the possibility of the arrested person becoming endangered by the debilitating effects of any injury or suspension trauma, the latter of which has the capability of causing expiration through a collapse in metabolism caused by motionless suspension in a safety harness.

Various additional features may be used with or incorporated with the present invention without departing from its scope, which are not illustrated, as follows:

Any of the embodiments of the invention may be applied to a vertical or leaning ladder.
Rest platforms may be installed at intervals up the ladder.
Gate devices may be installed at any point on the track, irrespective of orientation, to allow the sliding device to be attached or detached at those points according to work requirements. Alternatively, an opening device may be incorporated within the sliding device itself, to allow it to be attached to or detached from the track at any point.
Turntables or switches, which enable a person to transfer the sliding device from plane to plane, or to transfer between near-parallel routes.
Leaning ladders may be lashed to the supporting structure.
Leaning ladders may be stabilised with an effective ladder stability augmentation device.

1. A fall-arrest system for a person climbing a ladder affixed to or supported by a structure, comprising:
an elongate track securable to the ladder so as to lie adjacent to the intended route of a person climbing or descending the ladder;
a sliding device which in use is coupled to the elongate track and configured to be freely displaceable therealong when the person is climbing the ladder;
a safety line extending from the sliding device for attachment to a harness attachment point of a safety harness worn by the person climbing or descending the ladder, the sliding device incorporating a locking mechanism configured to allow the sliding device to freely slide along the elongate track during normal movement of the person connected thereto by the safety line and to automatically lock the sliding device to the elongate track in the event of the person falling from said ladder;
wherein the elongate track comprises a flexible belt configured to depend from an upper end of the ladder.

2. A fall-arrest system according to claim 1, wherein the sliding device comprises a first part engaging the flexible belt and a second part coupled to the safety line, with the second part configured to move relative to the first part from a first position to a second position to activate the locking mechanism in order to lock the sliding device to the flexible belt.

3. A fall-arrest system according to claim 2, wherein the second part is constrained to move relative to the first part from the first position to the second position in a direction parallel to the flexible belt engaging the first part.

4. A fall-arrest system according to claim 2, wherein the first part defines an open channel having a profile configured to receive and retain the flexible belt therein when sliding therealong, the profile being configured to allow the sliding device to pass a linkage anchoring the flexible belt to the ladder.

5. A fall-arrest system according to claim 2, wherein the locking mechanism comprises a locking lever pivotally coupled to the first part, the locking lever having: a distal end furthest from the flexible belt which is pivotally coupled to the second part; and a proximal end closest to the flexible belt which is configured to pivot towards the flexible belt in response to movement of the second part relative to the first part from the first position to the second position.

6. A fall-arrest system according to claim 5, wherein the locking lever is configured to trap the flexible belt between the proximal end and the first part in response to movement of the second part relative to the first part from the first position to the second position.

7. A fall-arrest system according to claim 2, wherein the second part is urged to remain in the second position relative to the first part by a resilient bias.

8. A fall-arrest system according to claim 7, wherein the resilient bias is configured to be exceeded by an opposing force transmitted to the second part by the safety line and created during controlled ascent or descent, whereby the second part moves to the first position.

9. A fall-arrest system according to claim 8, wherein the resilient bias is configured to move the second part from the first position to the second position as soon as the opposing force is removed, and particularly in the event of a person falling from the ladder.

10. A fall-arrest system according to claim 1, wherein at least a portion of the safety line is rigid or substantially rigid such that, when the portion of the elongate track on which the sliding device is positioned is orientated in a vertical or inclined direction, the sliding device is supported on the harness attachment point via the substantially rigid portion of the safety line, maintaining the sliding device above the harness attachment point minimising the distance through which a person might free fall before the locking mechanism is actuated in the event of a fall.

11. A fall-arrest system according to claim 10, wherein the rigid or substantially rigid portion of the safety line comprises a rigid or substantially rigid tube encasing the safety line and wherein the rigid or substantially rigid tube encasing the safety line is slidable therealong.

12. (canceled)

13. A fall-arrest system according to claim 11, wherein the safety line encased by the rigid or substantially rigid tube is wound on a spring-loaded reel within the body of the sliding device such that it is automatically extendible and retractable.

14. A fall-arrest system according to claim 13, wherein the spring-loaded reel comprises a locking mechanism to lock the reel if the reel rotates at a velocity exceeding a predetermined limit which is indicative of a person falling off the ladder.

15. A fall-arrest system according to claim 1, wherein the flexible belt comprises: a first flexible belt component configured to be secured to the ladder; and a second flexible belt component secured to the first belt component by a plurality of linkages spaced along the first and second flexible elongate components, the plurality of linkages being configured to maintain a gap between the first and second flexible belt components and to allow the sliding device to slide freely along the second flexible belt component.

16. A fall-arrest system according to claim 15, wherein the sliding device comprises a part defining an open channel for slidably receiving the second elongate flexible belt component therethrough, the open channel having a profile which is configured to retain the second flexible belt component therein whilst allowing the sliding device to pass at least one of the plurality of linkages when sliding along the second elongate flexible belt component.

17. A fall-arrest system according to claim 15, further comprising at least one coupling configured to secure the first flexible belt component to a rung of the ladder, the at least one coupling being slidable along the first flexible belt between an adjacent pair of the plurality of linkages.

18. A fall-arrest system according to claim 17, wherein the at least one coupling comprises a sleeve through which the first elongate flexible belt component is threaded.

19. A fall-arrest system according to claim 1, wherein the flexible belt has teeth configured to mesh with and rotate a cogwheel rotatably mounted in the sliding device as the sliding device slides along the flexible belt, with the locking mechanism of the sliding device being configured to stop further rotation of the cogwheel if rotation of the cogwheel exceeds a predetermined angular velocity.

20. A fall-arrest system according to claim 1, wherein the flexible belt is configured to be held taut between the upper end of the ladder and a lower end of the ladder.

21. A fall-arrest system according to claim 20, wherein the flexible belt is a continuous loop belt
